(19) United States
(12) Patent Application Publication
(10) Pub. No.: US 2018/0319579 A1
(43) Pub. Date: Nov. 8, 2018

(54) COMPACTLY TRANSPORTABLE COLLAPSIBLE CONTAINER FOR PERRISHABLE GOODS

(71) Applicant: Eco Pack Green Box USA LLC, Karmey Yosef (IL)

(72) Inventor: Yosef Heyman, Karmey Yosef (IL)

(73) Assignee: Eco Pack Green Box USA LLC, Karmey Yosef (IL)

(21) Appl. No.: 15/774,095

(22) PCT Filed: Nov. 3, 2016
(86) PCT No.: PCT/IL2016/051192

§ 371 Date: May 7, 2018

Related U.S. Application Data
(60) Provisional application No. 62/251,113, filed on Nov. 5, 2015.

(51) Int. Cl. B65D 85/34; A23B 7/148; B65D 81/26; B65D 81/28; B65D 81/20; B65B 25/04; B65B 31/04

(52) U.S. Cl. CPC B65D 85/34; A23B 7/148; B65D 81/266; A23V 2002/00; B65D 81/2023; B65B 25/041; B65B 31/041; B65D 81/28

(57) ABSTRACT

A controllable atmosphere collapsible container for perishable goods comprises a sealable bag accommodating the perishable goods and means for controlling atmosphere therewithin. The bag is mechanically connected to collapsible frame further comprising: (a) a concatenate rectangular carrying sub-frame; (b) concatenate supporting members releasably connectable to the rectangular carrying sub-frame. The bag is downwardly housed into the rectangular carrying sub-frame and configured for accommodating the perishable goods.

### FIELD OF THE INVENTION

The present invention is related to packaging, shipping and warehousing, and more specifically, to a collapsible container for perishable goods configured for transporting in a controllable atmosphere.

### BACKGROUND OF THE INVENTION

The storability of fruits and vegetables is strictly related to their respiration rate, which is an expression of metabolic activity. Aerobic respiration requires O₂, and results in CO₂ and heat release. More than 95% of the energy released is lost as heat. The temperature decrease, in particular if helped by modification of the atmosphere leads to a reduction in respiration rate, and therefore to an increase in storage life in fruits with climacteric respiration. Selection of the most suitable atmosphere depends on cultivars, stage of maturity, environmental and cultivation parameters. No one atmosphere is best for all produce, specific recommendations and cautions must be determined for each crop over the range of storage temperature and periods.

U.S. Pat. No. 8,783,002 discloses a method for introducing at least one substance into a sealed enclosure holding at least one product. At least one conduit may be provided through which one of gas or fluid may flow into or out of the sealed enclosure. Air may be evacuated from the sealed enclosure through the at least one conduit to create a predetermined pressure within the sealed enclosure and a predetermined quantity of the at least one substance may be injected into the sealed enclosure through the at least one conduit.

U.S. Pat. No. 9,034,405 discloses combinations of atmosphere control members used to control the atmosphere within a sealed container which contains a respiring biological material. The combination makes use of a first ACM having a first R ratio (the ratio of carbon dioxide permeability to oxygen permeability) and a second ACM having a second R ratio, the first R ratio being substantially greater than 1.0, and the second R ratio being less than the first R ratio. This combination can form part of the sealed container itself, or can be part of an assembly through which the packaging atmosphere within the sealed container is circulated.

The controllable atmosphere containers known in the prior are characterized by stiff wall and bottom elements. Fruits or other perishable goods when transported or stored are damaged due to mechanical contact with the stiff wall and bottom elements. Thus, there is a long-felt and unmet need to provide a controllable atmosphere container where perishable goods are not damaged by the wall and bottom elements.

### SUMMARY OF THE INVENTION

It is hence one object of the invention to disclose a controllable atmosphere collapsible container for perishable goods. The aforesaid container comprises a sealable bag accommodating the perishable goods and means for controlling atmosphere therewithin.

It is a core purpose of the invention to provide the bag mechanically connected to collapsible frame further comprising: (a) a concatenate rectangular carrying sub-frame: (b) concatenate supporting members releasably connectable to the rectangular carrying sub-frame. The bag is downwardly housed into the rectangular carrying sub-frame and configured for accommodating the perishable goods.

Another object of the invention is to disclose the bag made of a material selected from the group consisting of PVC, polypropylene, polystyrene, polyethylene and any combination thereof.

A further object of the invention is to disclose the means for controlling atmosphere comprising a gas absorbing member.

A further object of the invention is to disclose the gas absorbing member comprising an ethylene absorber material, an oxygen absorber material, an ozone absorber material and any combination thereof.

A further object of the invention is to disclose the ethylene absorbent material comprising charcoal and palladium chloride.

A further object of the invention is to disclose the means for controlling atmosphere comprising gaseous filler.

A further object of the invention is to disclose the gas filler selected from the group consisting of ozone, carbon dioxide, oxygen, nitrogen and any combination thereof.

A further object of the invention is to disclose the means for controlling atmosphere comprising a material selected from the group consisting of an antibacterial agent, a desiccating agent, an antifungal agent.

A further object of the invention is to disclose the bag made of a selectively gas-permeable membrane material.

A further object of the invention is to disclose bag comprising at least one charged polymer characterized, when in contact with a water-containing environment, as: (a) carrying strongly acid and/or strongly basic functional groups; (b) having a pH of less than about 4.5 or greater than about 8.0. (c) capable of generating an electrical potential within the confined volume of said cell sufficient to disrupt effectively the pH homeostasis and/or electrical balance within said confined volume of said cell; and, (d) being in a form chosen from the group consisting of (i) H⁺ and (ii) OH⁻.

A further object of the invention is to disclose the bag made of a composite material for preservation of a crop. The material comprises: a non-woven fabric in non-covalent association with an microencapsulated essential oil, the essential oil having activity selected from insect-repellant, fungicidal, fungistatic, bactericidal, bacteriostatic and/or spoilage retardant effect; said microencapsulated essential oil embedded in or adhering to the non-woven fabric.

A further object of the invention is to disclose the bag which is a water vapor permeable plastic bag. At least one sealable localized atmosphere communication aperture is formed in a wall of said box and communicating with the interior of said bag. A sealing element is located in said at least one sealable localized atmosphere communication aperture.

A further object of the invention is to disclose the container comprising: a plurality of sensor assemblies for sensing at least one parameter of packaged produce at a plurality of times and locations of said packaged produce; at least one transceiver receiving information relating to said at least one parameter of packaged produce from said plurality of sensor assemblies; a communications network operative to receive information relating to said at least one parameter of packaged produce at said plurality of times and locations of said packaged produce sensed by multiple sensor assemblies from said at least one transceiver to transmit said information to at least one information receiving location; and at least one computer at said at least one information receiving location for receiving said information transmitted by said at least one transceiver via said communications network and for providing an information output relating to said at least one parameter of packaged produce at said plurality of times and locations of said packaged produce sensed by multiple sensor assemblies.

A further object of the invention is to disclose a method of transportation or storing perishable goods in controllable atmosphere. The aforesaid method comprises the steps of: (a) providing at least one the container comprising a sealable bag accommodating the perishable goods and means for controlling atmosphere therewithin; the bag is mechanically connected to collapsible frame further comprising: (i) a concatenate rectangular carrying sub-frame; (ii) concatenate supporting members releasably connectable to the rectangular carrying sub-frame; the bag is downwardly housed into the rectangular carrying sub-frame and configured for accommodating the perishable goods; (b) providing an air-removal apparatus, (c) assembling the container; (d) loading the bag with the perishable goods, (e) controlling internal atmosphere of the bag; (f) transporting or storing the perishable goods to/at a point interest; (g) unloading the container, and (h) dissembling the container.

A further object of the invention is to disclose the step of controlling internal atmosphere comprising sub-steps of removing remaining air from the bag; placing means for controlling atmosphere into the bag; and sealing the bag by means the covering member.

A further object of the invention is to disclose the step of controlling internal atmosphere comprising placing a gas absorbing member into the bag.

A further object of the invention is to disclose the step of controlling internal atmosphere comprising placing gaseous filler into the bag.

A further object of the invention is to disclose a kit for packaging perishable goods comprising: (a) at least one container comprising a sealable bag accommodating the perishable goods and means for controlling atmosphere therewithin; (b) an air-removal apparatus.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a isometric view of a supporting frame;

FIGS. 2a and 2b schematically illustrate bag securement to a sub-frame.

FIG. 3 is a photograph of a controllable atmosphere collapsible container loaded with bananas.

### DETAILED DESCRIPTION OF THE INVENTION

The following description is provided, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a controllable atmosphere collapsible container for perishable goods, a method of storing and transporting the perishable goods and a kit for performing the same.

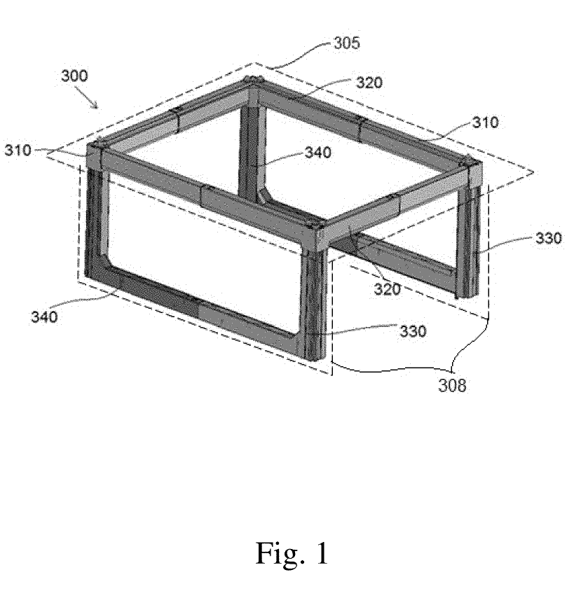

Reference is now made to FIG. 1, showing an exemplar supporting frame 300 which comprises sub-frame 305 and Π-shaped members 308. Sub-frame 305 includes two pairs of Γ-shaped members 310 and 320 interconnected with each other. Each Π-shaped member 308 includes Γ-shaped members 330 and 340. Free ends of interconnected Γ-shaped members 330 and 340 are connected to sub-frame 305.

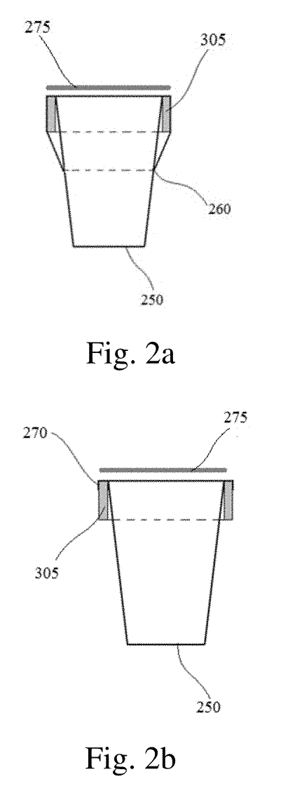

Reference is now made to FIGS. 2a and 2b, illustrating bag securement to a sub-frame 305. In FIG. 2a, bag has main portion 250 for accommodating the goods in bulk and a rim portion 270 of the bag. Main portion 250 is sealable by a cover member 275 when the perishable goods are loaded remaining air is evacuated from the bag by an air-removal apparatus (not shown). The rim portion is bent over sub-frame 305 and mechanically secured to outer surface 260 of the main portion 250 of the bag. The portion 320 for accommodating the goods is downwardly housed into the rectangular carrying sub-frame 305 such that goods to be loaded, stored or shipped within the portion 320 can be placed in its internal volume so formed.

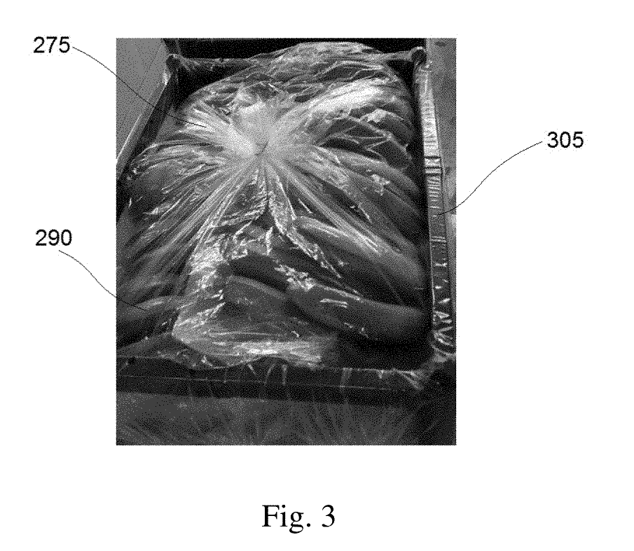

Reference is now made to FIG. 3, presenting a general view of controllable atmosphere collapsible container for perishable goods loaded by bananas 290 which is sealed in the bag by means of cover member 275.

The internal atmosphere in the bag can be controlled by filling the bag with a gaseous filler at hyper pressure or placing within the bag a gas absorber (for example, an absorber of oxygen, carbon dioxide or ethylene). Charcoal with palladium chloride as the ethylene absorbent material comprises is also in the scope of the present invention. Carbon dioxide, oxygen, nitrogen and any combination thereof are usable as gas filler in the present invention. Antibacterial, desiccating and antifungal agents are also internally applicable in bag portion 320. The aforesaid agents can be applied by smearing, spraying, painting or alike.

According to another embodiment of the present invention, the bag is made of a selectively gas-permeable membrane material.

The proposed technical solution provides a controllable atmosphere container where perishable goods are not damaged by the wall and bottom elements.

An alternative embodiment of the present invention illustrated in FIG. 2b, rim portion 270 is mechanically secured to sub-frame 305. The bag can be of a rectangular cross-section enlarging from a bottom to the rim portion. The bag is secured to the frame by means of glue, clamps, sutures and any combination thereof.

The bag can include at least one charged polymer, which is characterized, when in contact with a water-containing environment, as: carrying strongly acid and/or strongly basic functional groups; having a pH of less than about 4.5 or greater than about 8.0; capable of generating an electrical potential within the confined volume of said cell sufficient to disrupt effectively the pH homeostasis and/or electrical balance within said confined volume of said cell; and, being in a form chosen from the group consisting of (i) H⁺ and (ii) OH⁻.

According to one embodiment of the present invention, the bag is made of a composite material for preservation of a crop. The aforesaid material comprises: a non-woven fabric in non-covalent association with a microencapsulated essential oil. The essential oil has activity selected from insect-repellant, fungicidal, fungistatic, bactericidal, bacteriostatic and/or spoilage retardant effect. The microencapsulated essential oil embedded in or adhering to the non-woven fabric.

According to one embodiment of the present invention, the bag is a water vapor permeable plastic bag. At least one sealable localized atmosphere communication aperture is formed in a wall of said box and communicates with the interior of the bag. A sealing element is located in the at least one sealable localized atmosphere communication aperture.

According to one embodiment of the present invention, the container comprises: a plurality of sensor assemblies for sensing at least one parameter of packaged produce at a plurality of times and locations of said packaged produce; at least one transceiver receiving information relating to said at least one parameter of packaged produce from said plurality of sensor assemblies; a communications network operative to receive information relating to said at least one parameter of packaged produce at said plurality of times and locations of said packaged produce sensed by multiple sensor assemblies from said at least one transceiver to transmit said information to at least one information receiving location; and at least one computer at said at least one information receiving location for receiving said information transmitted by said at least one transceiver via said communications network and for providing an information output relating to said at least one parameter of packaged produce at said plurality of times and locations of said packaged produce sensed by multiple sensor assemblies.

According to the present invention, a controllable atmosphere collapsible container for perishable goods is disclosed. The aforesaid container comprises a sealable bag accommodating the perishable goods and means for controlling atmosphere therewithin.

It is a core purpose of the invention to provide the bag mechanically connected to collapsible frame further comprising: (a) a concatenate rectangular carrying sub-frame; (b) concatenate supporting members releasably connectable to the rectangular carrying sub-frame. The bag is downwardly housed into the rectangular carrying sub-frame and configured for accommodating the perishable goods.

According to one embodiment of the present invention, the bag made of a material is selected from the group consisting of PVC, polypropylene, polystyrene, polyethylene and any combination thereof.

According to another embodiment of the present invention, the means for controlling atmosphere comprises a gas absorbing member.

According to another embodiment of the present invention, the gas absorbing member comprises an ethylene absorber material, an oxygen absorber material, an ozone absorber material and any combination thereof.

According to another embodiment of the present invention, the ethylene absorbent material comprises charcoal and palladium chloride.

According to a further embodiment of the present invention, the means for controlling atmosphere comprises gaseous filler.

According to another embodiment of the present invention, the gas filler is selected from the group consisting of carbon dioxide, oxygen, nitrogen and any combination thereof.

According to another embodiment of the present invention, the means for controlling atmosphere comprises a material selected from the group consisting of an antibacterial agent, a desiccating agent, an antifungal agent.

According to another embodiment of the present invention, the bag is made of a selectively gas-permeable membrane material.

According to a further embodiment of the present invention, a method of transportation or storing perishable goods in controllable atmosphere is disclosed. The aforesaid method comprises the steps of: (a) providing at least one the container comprising a sealable bag accommodating the perishable goods and means for controlling atmosphere therewithin; the bag is mechanically connected to collapsible frame further comprising: (i) a concatenate rectangular carrying sub-frame; (ii) concatenate supporting members releasably connectable to the rectangular carrying sub-frame; the bag is downwardly housed into the rectangular carrying sub-frame and configured for accommodating the perishable goods; (b) providing an air-removal apparatus; (c) assembling the container; (d) loading the bag with the perishable goods, (e) controlling internal atmosphere of the bag; (f) transporting or storing the perishable goods to/at a point interest; (g) unloading the container, and (h) dissembling the container.

According to a further embodiment of the present invention, the step of controlling internal atmosphere comprises sub-steps of removing remaining air from the bag; placing means for controlling atmosphere into the bag; and sealing the bag by means the covering member.

According to a further embodiment of the present invention, the step of controlling internal atmosphere comprises placing a gas absorbing member into the bag.

According to a further embodiment of the present invention, the step of controlling internal atmosphere comprises placing gaseous filler into the bag.

According to a further embodiment of the present invention, a kit for packaging perishable goods comprises: (a) at least one container comprising a sealable bag accommodating the perishable goods and means for controlling atmosphere therewithin; (b) an air-removal apparatus.

We claim:

1. A controllable atmosphere collapsible container for perishable goods; said container comprising a sealable bag accommodating said perishable goods; said bag is mechanically connected to collapsible frame further comprising:
a. a concatenate rectangular carrying sub-frame;
b. concatenate supporting members releasably connectable to said rectangular carrying sub-frame;
said bag is downwardly housed into the rectangular carrying sub-frame and configured for accommodating said perishable goods;
and wherein said container comprises means for controlling atmosphere within said sealable bag.

2. The container according to claim 1, wherein at least one of following is true:
a. said bag is made of a material selected from the group consisting of PVC, polypropylene, polystyrene, polyethylene and any combination thereof:
b. said means for controlling atmosphere comprises a gas absorbing member:
c. said means for controlling atmosphere comprises gaseous filler,
d. said means for controlling atmosphere comprises a material selected from the group consisting of an antibacterial agent, a desiccating agent, an antifungal agent;
e. said bag is made of a selectively gas-permeable membrane material;
f. said bag made of a composite material for preservation of a crop, said material comprising: a non-woven fabric in non-covalent association with an microencapsulated essential oil, the essential oil having activity selected from the group consisting of an insect-repellant effect, a fungicidal effect, a fungistatic effect, a bactericidal effect, a bacteriostatic effect, a spoilage retardant effect and any combination thereof; said microencapsulated essential oil embedded in or adhering to the non-woven fabric: water content of the composite material is less than 10%;
g. said bag being a water vapor permeable plastic bag; said bag having at least one sealable localized atmosphere communication aperture formed in a wall of said bag and communicating with the interior of said bag and a sealing element, located in said at least one sealable localized atmosphere communication aperture.

3. The container according to claim 2, wherein said gas absorbing member comprises an ethylene absorbent material, an oxygen absorber material, an ozone absorber material and any combination thereof.

4. The container according to claim 3, wherein said ethylene absorbent material, comprises charcoal and palladium chloride.

5. The container according to claim 2, wherein said gaseous filler is selected from the group consisting of ozone, carbon dioxide, oxygen, nitrogen and any combination thereof.

6. The container according to claim 1, Said bag comprises at least one charged polymer, said at least one charged polymer characterized, when in contact with a water-containing environment, as:
a. carrying strongly acid and/or strongly basic functional groups;
b. having a pH of less than about 4.5 or greater than about 8.0;
c. capable of generating an electrical potential within the confined volume of said cell sufficient to disrupt effectively the pH homeostasis and/or electrical balance within said confined volume of said cell, and,
d. being in a form chosen from the group consisting of (i) H⁺ and (ii) OH⁻.

7-32. (canceled)

33. The container according to claim 1, comprising: a plurality of sensor assemblies for sensing at least one parameter of packaged produce at a plurality of times and locations of said packaged produce; at least one transceiver receiving information relating to said at least one parameter of packaged produce from said plurality of sensor assemblies; a communications network operative to receive information relating to said at least one parameter of packaged produce at said plurality of times and locations of said packaged produce sensed by multiple sensor assemblies from said at least one transceiver to transmit said information to at least one information receiving location; and at least one computer at said at least one information receiving location for receiving said information transmitted by said at least one transceiver via said communications network and for providing an information output relating to said at least one parameter of packaged produce at said plurality of times and locations of said packaged produce sensed by multiple sensor assemblies.

34. A method of transportation or storing perishable goods in controllable atmosphere; said method comprising the steps of:
e. providing at least one said container comprising a sealable bag accommodating said perishable goods and means for controlling atmosphere therewithin; said bag is mechanically connected to collapsible frame further comprising:
i. a concatenate rectangular carrying sub-frame;
ii. concatenate supporting members releasably connectable to said rectangular carrying sub-frame;
said bag is downwardly housed into the rectangular carrying sub-frame and configured for accommodating said perishable goods;
f. providing an air-removal apparatus;
g. assembling said container;
h. loading said bag with said perishable goods,
i. controlling internal atmosphere of said bag;
j. transporting or storing said perishable goods to/at a point interest;
k. unloading said container; and
l. dissembling said container.

35. The method according to claim 34, wherein at least one of following is true:
m. said step of controlling internal atmosphere comprises sub-steps of removing remaining air from said bag; placing means for controlling atmosphere into said bag; and sealing said bag by means said covering member;
n. said bag is made of a material selected from the group consisting of PVC, polypropylene, polystyrene, polyethylene and any combination thereof;
o. means for controlling atmosphere comprises a material selected from the group consisting of an antibacterial agent, a desiccating agent, an antifungal agent;
p. said bag is made of a selectively gas-permeable membrane material.

36. The container according to claim 35, wherein said step of controlling internal atmosphere comprises placing a gas absorbing member into said bag.

37. The container according to claim 36, wherein said gas absorbing member comprises an ethylene absorber material, an oxygen absorber material, an ozone absorber material and any combination thereof.

38. The container according to claim 37, wherein said ethylene absorbent material comprises charcoal and palladium chloride.

39. The container according to claim 34, wherein said step of controlling internal atmosphere comprises placing gaseous filler into said bag.

40. The container according to claim 39, wherein said gas filler is selected from the group consisting of ozone, carbon dioxide, oxygen, nitrogen and any combination thereof.

41. A kit for packaging perishable goods comprising:
a. at least one container comprising a sealable bag accommodating said perishable goods and means for controlling atmosphere therewithin;
b. air removal apparatus;
said bag is mechanically connected to collapsible frame further comprising:
i. a concatenate rectangular carrying sub-frame;
ii. concatenate supporting members releasably connectable to said rectangular carrying sub-frame;
said bag is downwardly housed into the rectangular carrying sub-frame and configured for accommodating said perishable goods.

42. The kit according to claim 41, wherein at least one of the following is true:
a. said bag is made of a material selected from the group consisting of PCV, polypropylene, polystyrene, polyethylene and any combination thereof;
b. said means for controlling atmosphere comprises a gas absorbing member;
c. said means for controlling atmosphere comprises gaseous filler;
d. means for controlling atmosphere comprises a material selected from the group consisting of an antibacterial agent, a desiccating agent, an antifungal agent;
e, said bag is made of selectively gas-permeable membrane material.

43. The container according to claim 42, wherein said gas absorbing member comprises an ethylene absorber material, an oxygen absorber material, an ozone absorber material and any combination thereof.

44. The container according to claim 43, wherein said ethylene absorbent material comprises charcoal and palladium chloride.

45. The container according to claim 42, wherein said gas filler is selected from the group consisting of ozone, carbon dioxide, oxygen, nitrogen and any combination thereof.
